(19) United States
(12) Patent Application Publication
(10) Pub. No.: US 2026/0189551 A1
(43) Pub. Date: Jul. 2, 2026

(54) ACCESS CREDENTIAL SORTING

(71) Applicant: Wells Fargo Bank, N.A., San Francisco, CA (US)

(72) Inventors: Eric J. Miller, Minneapolis, MN (US); Carolee Ann-Eckert Peterson, Brooklyn Park, MN (US); Clifford R. Bloom, Minneapolis, MN (US); Patrick J. Helwig, St. Paul, MN (US); Carrie Anne Hanson, Charlotte, NC (US)

(21) Appl. No.: 19/007,524

(22) Filed: Jan. 1, 2025

(51) Int. Cl. H04L 9/40

(52) U.S. Cl. CPC H04L 63/0853

(57) ABSTRACT

System and techniques to sort and order a database of access credentials are described herein. A device can receive a signal indicating participation in an access transaction. The device can then obtain context data corresponding to the access transaction and search, based on the context data, a local data store of the device to locate a subset of access credentials from a set of access credentials stored in the local data store. The device can order members of the subset of access credentials based on a predefined metric to create an ordered subset of access credentials and render the ordered subset of access credentials to a user interface of the device for selection by a user of the handheld device to complete the access transaction.

### TECHNICAL FIELD

Embodiments described herein generally relate to structured data retrieval and more specifically to access credential sorting.

### BACKGROUND

Access credentials encompass various forms of authentication used across multiple industries to verify identity and permit access to systems, facilities, or services. These credentials may include digital passkeys, physical door keys, credit cards, biometric data, RFID cards, security tokens, and mobile-based authentication techniques. Passkeys are typically digital or electronic mechanisms that enable access to secured systems or locations, often in conjunction with dedicated authentication software or hardware. Door keys operate mechanical devices that control physical access to locked areas, while credit cards facilitate financial transactions and include security features such as magnetic stripes or embedded chip technology for identity verification.

Biometric credentials, including fingerprint or facial recognition technologies, are commonly used in sectors such as healthcare and government for secure access to sensitive data or restricted areas. RFID cards are widely employed in industries like transportation, manufacturing, or hospitality to regulate entry to restricted zones. Security tokens, which may include physical devices or one-time passcodes, are often used in financial or technological sectors for securing online systems or digital services. Smart cards, incorporating chip technology, are frequently used in corporate, educational, or governmental settings to provide both physical access to buildings and secure network login capabilities. Mobile-based (e.g., handheld) authentication methods, such as NFC-enabled devices or application-based tokens, can be used in retail or banking sectors. Mobile driver's licenses (mDLs) are a form of digital identification, stored on handheld devices (e.g., smartphones) and used as legal proof of identity, such as in transportation or law enforcement contexts, offering enhanced security and privacy.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for access credential sorting, according to an embodiment.

FIG. 2 illustrates example data sources for context data, according to an embodiment.

FIG. 3 illustrates an example of rendering ordered access credentials from unordered storage based on context, according to an embodiment.

FIG. 4 illustrates a flow diagram of an example of a method for access credential sorting, according to an embodiment.

FIG. 5 is a block diagram illustrating an example of a machine upon which one or more embodiments may be implemented.

### DETAILED DESCRIPTION

In the contemporary digital environment, consumers are confronted with an extensive array of access credentials—including credit cards, debit cards, membership cards, benefit programs, and electronic keys for physical access to buildings—that they can utilize during transactions or access scenarios. While this abundance provides numerous opportunities for rewards, discounts, benefits, and secure access, it simultaneously imposes a burden on users who must select the most advantageous credential for each specific situation. The complexity in tracking which credential offers the optimal rewards or access privileges for a particular transaction or entry often leads to consumer confusion and missed opportunities for savings or efficient access.

Existing approaches to inform users about using access credentials have predominantly focused on delivering geographic notices (e.g., discounts based on location). For example, users may receive a coupon when they are in proximity to a store, incentivizing them to enter and make a purchase. These location-based offers aim to enhance foot traffic by leveraging the user's immediate surroundings. However, they do not assist users in selecting the optimal access credential from their personal collection at the point of sale (POS) or point of entry (POE).

Present techniques fail to address the personalized requirements of users who possess multiple access credentials, each with its distinct set of benefits (e.g., rewards, access privileges, access rights, etc.). Users frequently remain unaware of the full spectrum of benefits to which they are entitled, such as age-related discounts, membership perks, residency-based offers, or secure access to buildings via electronic keys. Verifying eligibility for certain discounts or access rights can be cumbersome, often necessitating physical proof like a utility bill, identification card, or manual entry of access codes, leading to inconvenience and potential errors or security risks. Consequently, users miss out on potential rewards or face inefficiencies in secure access, resulting in a less satisfactory experience and financial or operational inefficiencies.

To address these issues, access credential sorting can be used to enable users, at the POS or POE for example, by identifying which cards or credentials in their mobile wallet or digital keychain offer greater benefits for a particular transaction or entry than other available access credentials. Access credential sorting enables recommendations or reminders of various benefits a user is entitled to, including age-related discounts, membership benefits, residency-based offers, or secure electronic access to buildings. For example, by using information such as the address in a mobile driver's license (mDL) and integrating electronic key credentials, residency-based discounts or secure building access can be enabled without manual verification or additional authentication. Thus, the user experience is streamlined, and a user can better use access credentials available access credentials. Additional details and examples are provided below.

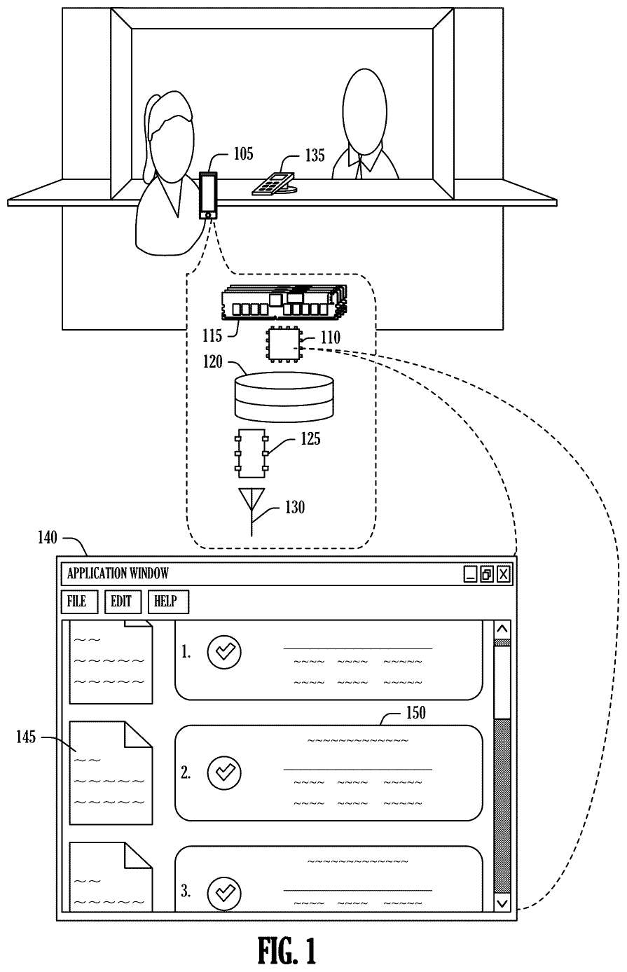

FIG. 1 is a block diagram of an example of an environment including a system 105 for access credential sorting, according to an embodiment. The system 105 includes processing circuitry 110, storage 120 (e.g., power-stable storage such as a hard drive, solid state drive, etc.), memory 115, and interface 125. The interface 125 can include an antenna 130 and circuitry to enable communication to or from the system 105. The memory 115 is generally used to maintain running state information for the system 105 that is usually discarded between system power cycles or restarts. The memory 115 and the storage 120 are both forms of computer readable media. The processing circuitry 110—or software residing in the memory 115 or storage 120 executing on the processing circuitry 110—configure the system 105 to perform various operations when running.

As noted above, the potentially large number of access credentials differently usable in various locations presents a challenge to users in selecting the access credential that is appropriate, or more beneficial, to the user for a given situation. To address this situation, the system 105 is configured to implement sorting of the access credentials based on a context for the system 105. Generally, the sorting orders the access credentials in a user interface for the user to select from with, for example, an indication as to why the ordering was performed. This enables the user to ultimately select the desired access credential while reducing the burden on the user to remember access credential consequences or searching through a long list of access credentials. For example, a person may have two access credentials for various locations within a building; one that is a general entry access credential that enables access to this person's office and a second that enables entry any room in the building. This second access credential may also trigger an audit of accesses due to the greater security implications of such access. If this person wanted to enter their office, both access credentials could be used but the first is probably preferable due to the consequences (e.g., costs) of using the second for routine access to an office. Here, given the context (e.g., a key swipe for the office and cost of using the universal access credential), the first access credential will be sorted higher and a brief explanation for the sorting presented to the user when attempting to gain access to the office.

To implement access credential sorting, the processing circuitry 110 is configured to receive (e.g., via the interface 125) a signal indicating participation in an access transaction. Here, an access transaction refers to a possibly multi-step interaction in which the system 105 will present an access transaction prior to completion of the transaction. For example, an access transaction can include a door lock with a near-field communication (NFC) beacon that alerts the system 105 (e.g., via the interface) when the system 105 is brought near the lock. The system 105 can present an access credential to the door lock that, when the access credential is accepted, unlocks the door to complete the access transaction. Other types of access transaction can include completion of a purchase (e.g., using a credit card access credential), voting, making a reservation, etc.

In an example, the system 105 is a handheld device. Having the system 105 be a handheld device, such as a mobile phone, tablet, or similar is a convenient form factor to enable the various access credentials to be carried with the user and applied where appropriate. Other form factors that are also convenient for this purpose can include a wristwatch form factor, rings, or other forms readily manipulated by the hands or arms to engage in access transactions.

The processing circuitry 110 is configured to obtain (e.g., retrieve or receive) context data corresponding to the access transaction. In an example, a portion of the context data is obtained from a sensor of the system 105. Such sensors can include cameras, microphones, or positioning systems (e.g., a satellite position system). In these cases, the context data obtained from the sensor can include who or what is near (e.g., a transaction terminal 135, a door, etc.), an environmental condition (e.g., temperature, weather, precipitation, etc.), or a time period (e.g., time of day, day of week, holiday, etc.). While a number of different contextual clues can effect aspects of an access credential, location is often tied to access. Accordingly, in an example, the portion of the context data is a physical location of the system 105. In an example, the sensor is a satellite positioning device. In these examples, geophysical location can effect access credential appropriateness. For example, a user can be granted access to a park during a seniors only period if the user is older than 65. In this case, an access credential that enables the user to verify their age, such as a mobile drivers license, can be sorted higher along with, for example, a park membership access credential.

In an example, a portion of the context data is received from the terminal 135 participating in the access transaction. In an example, the terminal 135 operates to unlock a door or a window. This is a typical scenario for electronically operated locks in buildings. In an example, the portion of the context data is an identification of the door or the window. In an example, the portion of the context data is an identification of a building or complex of buildings that includes the door or the window. As noted above, the specific portal, or area, to which access is sought can be governed by overlapping access credentials with possibly different impacts to the user depending upon which is used.

In an example, the terminal 135 operates to complete transactions for an operator. This sort of access transaction can often occur, when, for example, a user is purchasing something at a retailer. In an example, the portion of the context data includes an identification of the operator. This context can be useful in identifying access credentials that operate as loyalty discount cards or the like. Or, for example, if a certain access credential provides a greater number of “points” at the retailer than other access credentials.

In an example, the portion of the context data includes information about a transaction facilitated by the access transaction. In an example, the information about the transaction includes an amount, a type, or a restriction of an object subject to the transaction. The amounts can be used to rank (e.g., score, order, etc.) access credentials based on volume based thresholds for rewards or the like. A similar approach can be used for item types. For example, an access credential can provide a benefit if a certain brand of product is purchased at any retailer.

Object restriction can include such things as an age, residency, or status (e.g., membership in an organization, employment, unemployment, a parent, a caregiver, etc.) requirement to participate in the transaction at all or for a given exchange rate. For example, some products are typically age restricted. This can include a requirement that the user is below a certain age to purchase a “kids meal” at a restaurant to a requirement that the user be older than a certain age to purchase tobacco from a retailer. In these cases, a typical access credential to complete the exchange, such as a credit card, is different than the access credential used to verify the age of the user, such as a mobile driver's license. Accordingly, the age verification access credential can be ordered highly amongst access credentials even though it cannot be used alone to complete the exchange because the age verification access credential can be integral to the completion of the exchange.

The processing circuitry 110 is configured to search a local data store (e.g., in the storage 120 or the memory 115) of the system 105 to locate a subset of access credentials from a set of access credentials based on the context. Performing the search based on the context limits the subset of access credentials to those that can be used to complete the access transaction. Accordingly, payment credentials, such as credits cards, will likely not be returned by the search if the context indicates that the access transaction is to open a front door to the user's house. Similarly, door access credentials will likely not be provided in the subset of access credentials when the access transaction is registering to vote. In an example, the set of access credentials include a government identification, such as a mobile driver's license. Government identifications are likely in access transactions that are, or include a component of, verifying information about the user, such as identity, age, status (e.g., military, police, felon, etc.) or the like. Another type of access credential is a membership identification. These types of access credentials can include a membership card to a gymnasium, participation in a fan club, or other access credential that provide verification of information maintained by a non-governmental entity. In an example, the set of access credentials include a payment credential. These types of access credentials include account information sufficient to complete an exchange, typically of a currency for a good or a service.

The processing circuitry 110 is configured to order members of the subset of access credentials based on a predefined metric to create an ordered subset of access credentials. The predefined metric provides the configurable basis upon which ordering is made. For example, if all benefits of the members of the subset of access credentials are assigned a value in minutes (e.g., time saved by the user) as the predefined metric, then the access credentials can be ordered such that the highest value are ranked higher (e.g., more prominently to the user) than others. The predefined metric governs not only the units but the application of the units. For example, if the units are a currency, the metric can also define whether the benefit is measured in currency saved (e.g., discounts accumulated) or currency made (e.g., rewards granted). In an example, benefits of varying units are represented in a single unit based on the predefined metric. This can include reducing a free meal reward into a currency value to enable a comparison against a ten percent discount of a second access credential for a given exchange.

In an example, ordering the members of the subset of access credentials includes performing the ordering using a set of metrics to which the metric belongs. In this example, multiple metrics can be used. The combination of the multiple metric can be performed in a variety of ways, including using a weighted ordering, sorting on a first metric and then on a second metric such that results that are equal on the first metric are further ordered by the second metric, etc. In an example, the metric used for primary sorting or a higher weighting is random selected. This example enables a feeling of change or spontaneity that can increase the user experience without significantly impacting (e.g., within a predefined margin) the objective value to the user in selecting a higher ordered access credential.

The processing circuitry 110 is configured to render the ordered subset of access credentials to a user interface 140 of the system for selection by the to complete the access transaction. In an example, the user interface includes a visual element 150 that displays a portion of the set of metrics with respect to each displayed access credential 145. Here, the system 105 enables the user to select which access credential to use, ordered by virtue of benefit to the user as measured by the predefined metric. However, the visual element 150 also enables the user to make an informed decision that may be based on information that available to the context. For example, if an access credential has a benefit of donating a portion of an exchange transaction to fund an environmental cause, and the user felt that the environment was a priority for them after completing a hike in the wilderness, the user could locate this access credential further down the list obtain this benefit even when other access credentials might have provided a greater personal financial benefit to the user. Accordingly, in an example, the processing circuitry 110 is configured to receive selection of an access credential from the user interface 140.

Once the access credential is selected by the user, the system 105 can use the access credential (or multiple such as an identification credential and a payment credential) to complete the access transaction. In an example, a form of the access credential is transmitted (e.g., to the terminal 135) based on the selection from the user interface 140. In an example, a representation of the access credential can be rendered to a display of the handheld device based on the selection from the user interface and prior to transmission of the access credential. This last example would replace, or overlay, the ordered list of access credentials with the selected access credential (or credentials) to enable the user to verify the selection before the access transaction is complete.

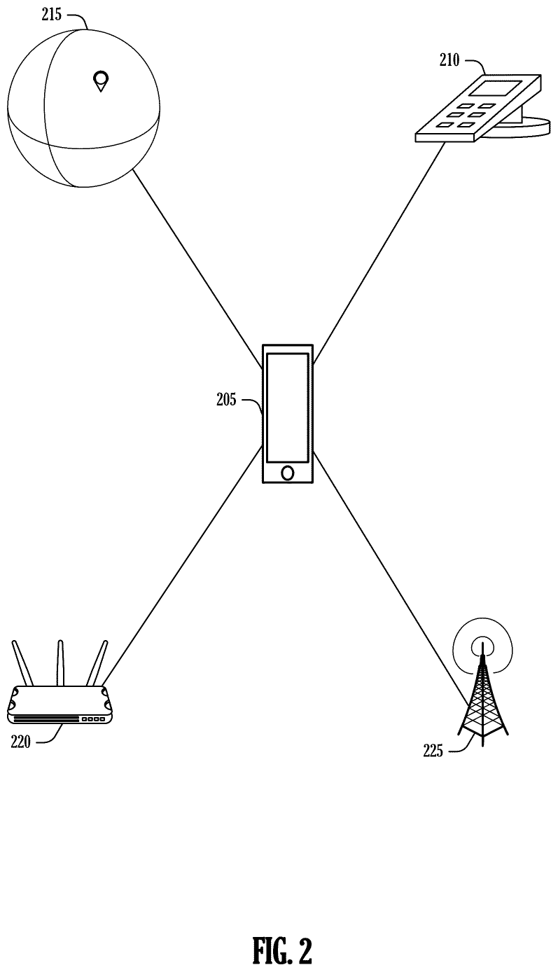

FIG. 2 illustrates example data sources for context data, according to an embodiment. The user device 205 facilitates use of access credentials on behalf of the user and is configured to receive context data from a number of sources. For example, the context data can include geographic location 215, provided, for example, from a satellite positioning system of the user device 205. Positioning information can be used to identify whether the user device 205—and by implication the user—are in a retailer, in a restricted zone, near an attraction, etc., to which a particular access credential is relevant (for the search of access credentials) or more beneficial (for the ordering of access credentials).

In an example, the context data can include information from a transaction terminal 210, or an access terminal (such as at a turnstile, door, window, etc.). Generally, this type of context information provides additional details about an access transaction that are mediated by another party to the access transaction, such as an account number to complete an exchange, a badge number to gain access to a room, etc.

In an example, the context data can include wireless data from an access point 220 (e.g., for close range, such as within 100 meter, data) or a cellular tower 225 (e.g., for long range data). Generally, this type of context information can be general, such as a broadcast to all user devices within range, or specific, directed to the user device 205. General data can include announcements (e.g., of events, attractions, etc.), weather information, or other data relevant to any person within an area. Specific context data can include notification of conditions or events specific to the user device 205.

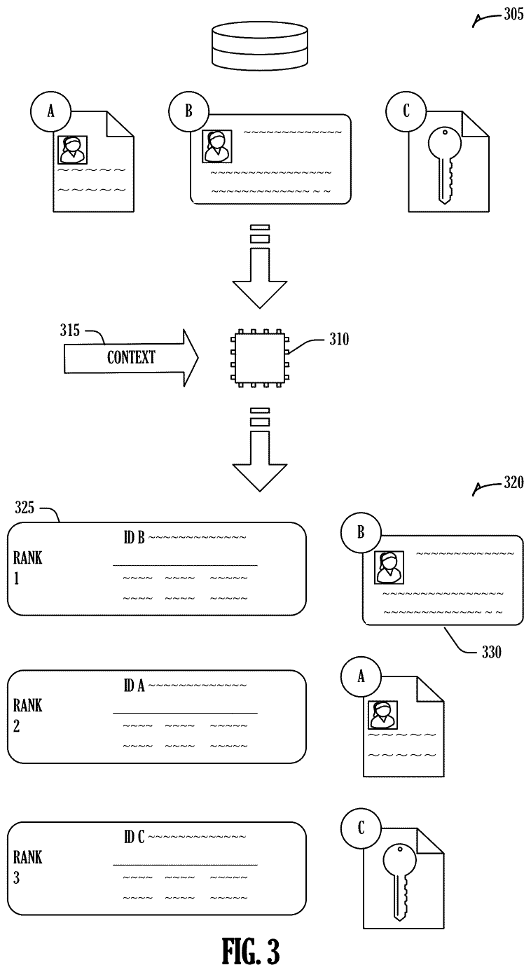

FIG. 3 illustrates an example of rendering ordered access credentials from unordered storage based on context, according to an embodiment. As illustrated, the system 305 includes storage with three types of access credentials, an identification credential A, a payment credential B, and a lock credential C (e.g., for a door). Given a context 315, the processing circuitry 310 of the system 305 orders the access credentials into a user interface 320. As illustrated, the user interface 320 has displayed a representation of the payment credential A 330 first (e.g., higher or more prominently) than the others and also includes a description of the benefits 325 for access credential A to enable a user to make informed choices with respect to selecting the displayed access credentials for a given access transaction.

Consider the following examples given an environment of an electronic wallet. During a wallet payment transaction, the wallet can identify which access credential (e.g., card) card provides the optimal benefit or reward for a given purchase. For example, one card may offer 2% cash back, while another may offer 4% cash back for the same transaction. This identification can be performed using geolocation, such as for merchant-specific rewards, or based on the actual transaction details. The system 305 can analyze the transaction context 315—including merchant, purchase amount, or applicable promotions—to determine the optimal card to use. Rules and preferences set by the user can correspond to rewards that automatically select the payment method. For instance, a user may prioritize travel points over cash back for certain purchases, and the system 305 can be instructed by the user to reflect these preferences. The context 315 can include real-time data analysis and user preferences to provide an efficient payment experience. By automatically identifying and suggesting the optimal card, the system 305 enables users to maximize rewards and benefits for each transaction. This approach enhances the user experience and promotes better access credential management by assisting users in making informed decisions.

The system 305 and the user interface 320 operate to alert users of various benefits to which the users are entitled. This may occur at the point of sale once a transaction begins, at the merchant location, or near the merchant. The system 305 can use the transaction context 315 data, a mobile driver's license (mDL) of a Very Smart Wallet (VSW), or benefit cards or applications (e.g., apps) installed on the system 305 to determine the benefits available. This functionality can use external sources (e.g., a vendor database)—for example, the system 305 (e.g., a phone) sends an mDL and transaction context 315 data to a server—or can use data on the system 305 itself, loyalty cards provisioned to the wallet, or communication with other applications on the system 305 (for instance, interacting with the A restaurant app when at the restaurant). The context 315 can include user geolocation, transaction details, products of interest identified via QR code scan, or similar information. The system 305 is configured to integrate various data points to create a seamless experience. By utilizing the mDL or other wallet elements, the system 305 can automatically identify applicable benefits and alert the user in real time. This ensures that users do not miss potential benefits (e.g., savings, rewards, etc.) to enhance the overall experience. Furthermore, the system 305 is configured to be customized to prioritize certain benefits based on user preferences, increasing efficiency and tailoring the system 305 to individual needs.

In an example, the system 305 uses the mDL to offer residence-based discounts at a point of sale. For instance, merchants may wish to encourage out-of-town visitors to frequent their establishments or aim to provide discounts to local residents. The system 305 can be configured to detect residency information from the mDL stored in the VSW and apply the appropriate discount during the transaction. This eliminates the need for manual verification and ensures accurate and efficient application of discounts.

In an example, the system 305 can be configured to include other information from the mDL to enable dynamic pricing. For example, age-based discounts for seniors or students can be automatically applied based on date-of-birth information in the mDL. Similarly, military, or veteran discounts can be offered based on relevant information stored in the mDL. This dynamic pricing capability enables businesses to tailor offers to specific customer segments, enhancing customer satisfaction and loyalty.

In an example, the system 305 can be configured to adjust a transaction to, for example, correct charge taxes on purchases based on residency information. For instance, if a user from a different state makes a purchase, the system 305 can be configured to calculate and apply the appropriate tax, ensuring compliance with tax regulations and reducing errors. The system 305 provides a secure environment to create a flexible and efficient technique for offering residency-based discounts or dynamic pricing. By facilitating the verification process by integration with the mDL, the system 305 provides a seamless experience for customers and businesses.

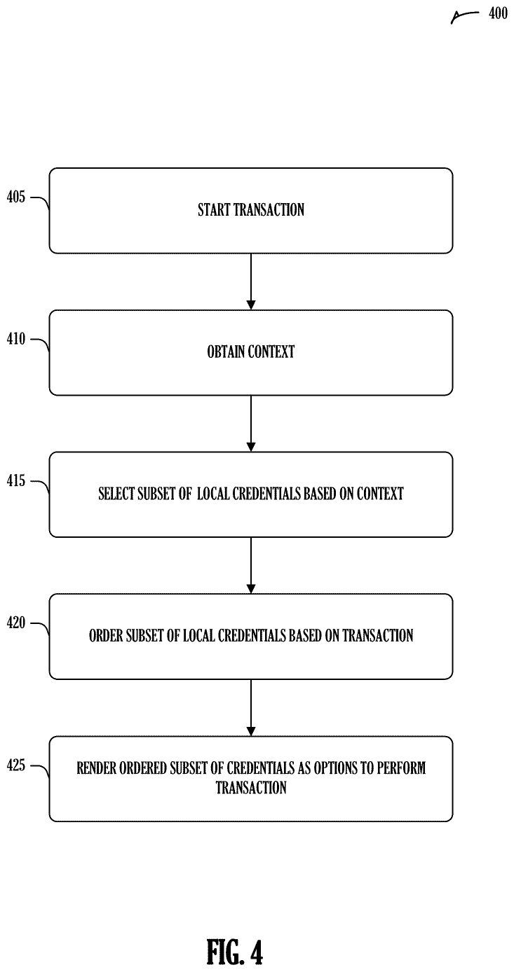

FIG. 4 illustrates a flow diagram of an example of a method 400 for access credential sorting, according to an embodiment. The method 400 is implemented in computational hardware, such as that described above or below (e.g., processing circuitry).

At operation 405 a signal indicating participation in an access transaction is received, for example, at a handheld device.

At operation 410, context data corresponding to the transaction is obtained (e.g., retrieved, received, created, etc.). In an example, a portion of the context data is obtained from a sensor of the handheld device. In an example, the portion of the context data is a physical location of the handheld device. In an example, the sensor is a satellite positioning device.

In an example, a portion of the context data is received from a terminal participating in the access transaction. In an example, the terminal operates to unlock a door or a window. In an example, the portion of the context data is an identification of the door or the window. In an example, the portion of the context data is an identification of a building or complex of buildings that includes the door or the window.

In an example, the terminal operates to complete transactions for an operator. In an example, the portion of the context data includes an identification of the operator. In an example, the portion of the context data includes information about a transaction facilitated by the access transaction. In an example, the information about the transaction includes an amount, a type, or a restriction of an object subject to the transaction.

At operation 415, a local data store of the handheld device is searched, based on the context, to locate a subset of access credentials from a set of access credentials stored in the local data store. In an example, the set of access credentials include a government identification. In an example, the set of access credentials include a payment credential.

At operation 420, members of the subset of access credentials are ordered based on a predefined metric to create an ordered subset of access credentials. In an example, ordering the members of the subset of access credentials includes performing the ordering using a set of metrics to which the metric belongs.

At operation 425, the ordered subset of access credentials is rendered to a user interface of the handheld device for selection by a user of the handheld device to complete the transaction. In an example, the user interface includes a visual element that displays a portion of the set of metrics with respect to each access credential displayed.

In an example, the operations of the method 400 can also include receiving selection of an access credential from the user interface. In an example, a form of the access credential can be transmitted based on the selection from the user interface. In an example, a representation of the access credential can be rendered to a display of the handheld device based on the selection from the user interface.

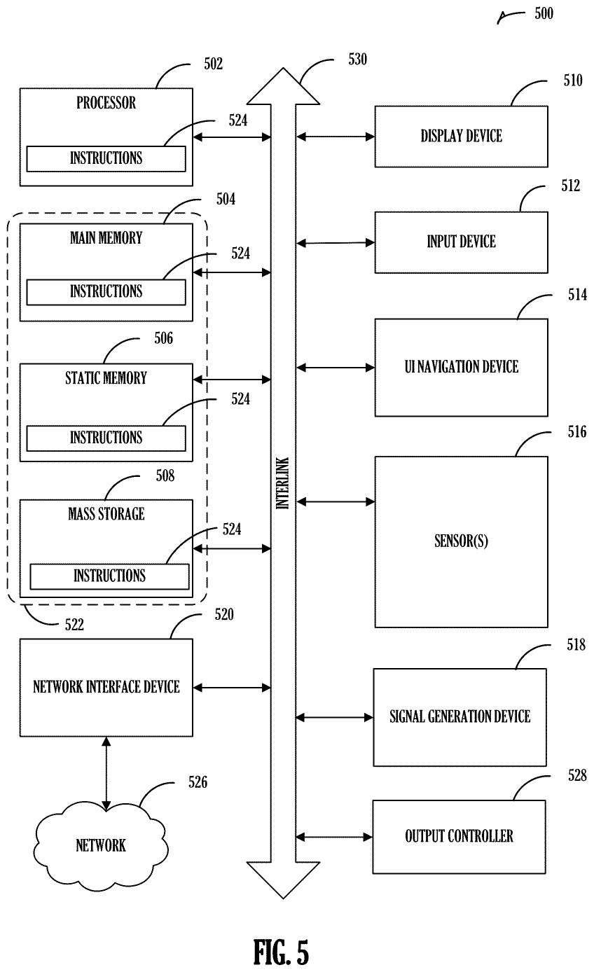

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is a device for access credential sorting, the device comprising: a memory including instructions; and processing circuitry that, when in operation, is configured by the instructions to: receive a signal indicating participation in an access transaction; obtain context data corresponding to the access transaction; search, based on the context data, a local data store of the device to locate a subset of access credentials from a set of access credentials stored in the local data store; order members of the subset of access credentials based on a predefined metric to create an ordered subset of access credentials; and render the ordered subset of access credentials to a user interface of the device for selection by a user of the device to complete the access transaction.

In Example 2, the subject matter of Example 1, wherein a portion of the context data is obtained from a sensor of the device.

In Example 3, the subject matter of Example 2, wherein the portion of the context data is a physical location of the device.

In Example 4, the subject matter of Example 3, wherein the sensor is a satellite positioning device.

In Example 5, the subject matter of any of Examples 1-4, wherein a portion of the context data is received from a terminal participating in the access transaction.

In Example 6, the subject matter of Example 5, wherein the terminal operates to unlock a door or a window.

In Example 7, the subject matter of Example 6, wherein the portion of the context data is an identification of the door or the window.

In Example 8, the subject matter of any of Examples 6-7, wherein the portion of the context data is an identification of a building or complex of buildings that includes the door or the window.

In Example 9, the subject matter of any of Examples 5-8, wherein the terminal operates to complete transactions for an operator.

In Example 10, the subject matter of Example 9, wherein the portion of the context data includes an identification of the operator.

In Example 11, the subject matter of any of Examples 9-10, wherein the portion of the context data includes information about an exchange facilitated by the access transaction.

In Example 12, the subject matter of Example 11, wherein the information about the exchange includes an amount, a type, or a restriction of an object subject to the exchange.

In Example 13, the subject matter of any of Examples 1-12, wherein, to order the members of the subset of access credentials, the processing circuitry is configured to perform the ordering using a set of metrics to which the metric belongs.

In Example 14, the subject matter of Example 13, wherein the user interface includes a visual element that displays a portion of the set of metrics with respect to each access credential displayed.

In Example 15, the subject matter of any of Examples 1-14, wherein the set of access credentials include a government identification.

In Example 16, the subject matter of any of Examples 1-15, wherein the set of access credentials include a payment credential.

In Example 17, the subject matter of any of Examples 1-16, wherein the processing circuitry is configured to receive selection of an access credential from the user interface.

In Example 18, the subject matter of Example 17, wherein the processing circuitry is configured to transmit a form of the access credential based on the selection from the user interface.

In Example 19, the subject matter of any of Examples 17-18, wherein the processing circuitry is configured to display a representation of the access credential to a display of the device based on the selection from the user interface.

Example 20 is a method for access credential sorting, the method comprising: receiving, at a handheld device, a signal indicating participation in an access transaction; obtaining context data corresponding to the access transaction; searching, based on the context data, a local data store of the handheld device to locate a subset of access credentials from a set of access credentials stored in the local data store; ordering members of the subset of access credentials based on a predefined metric to create an ordered subset of access credentials; and rendering the ordered subset of access credentials to a user interface of the handheld device for selection by a user of the handheld device to complete the access transaction.

In Example 21, the subject matter of Example 20, wherein a portion of the context data is obtained from a sensor of the handheld device.

In Example 22, the subject matter of Example 21, wherein the portion of the context data is a physical location of the handheld device.

In Example 23, the subject matter of Example 22, wherein the sensor is a satellite positioning device.

In Example 24, the subject matter of any of Examples 20-23, wherein a portion of the context data is received from a terminal participating in the access transaction.

In Example 25, the subject matter of Example 24, wherein the terminal operates to unlock a door or a window.

In Example 26, the subject matter of Example 25, wherein the portion of the context data is an identification of the door or the window.

In Example 27, the subject matter of any of Examples 25-26, wherein the portion of the context data is an identification of a building or complex of buildings that includes the door or the window.

In Example 28, the subject matter of any of Examples 24-27, wherein the terminal operates to complete transactions for an operator.

In Example 29, the subject matter of Example 28, wherein the portion of the context data includes an identification of the operator.

In Example 30, the subject matter of any of Examples 28-29, wherein the portion of the context data includes information about an exchange facilitated by the access transaction.

In Example 31, the subject matter of Example 30, wherein the information about the exchange includes an amount, a type, or a restriction of an object subject to the exchange.

In Example 32, the subject matter of any of Examples 20-31, wherein ordering the members of the subset of access credentials includes performing the ordering using a set of metrics to which the metric belongs.

In Example 33, the subject matter of Example 32, wherein the user interface includes a visual element that displays a portion of the set of metrics with respect to each access credential displayed.

In Example 34, the subject matter of any of Examples 20-33, wherein the set of access credentials include a government identification.

In Example 35, the subject matter of any of Examples 20-34, wherein the set of access credentials include a payment credential.

In Example 36, the subject matter of any of Examples 20-35, comprising receiving selection of an access credential from the user interface.

In Example 37, the subject matter of Example 36, comprising transmitting a form of the access credential based on the selection from the user interface.

In Example 38, the subject matter of any of Examples 36-37, comprising displaying a representation of the access credential to a display of the handheld device based on the selection from the user interface.

Example 39 is a machine readable medium including instructions for access credential sorting, the instruction, when executed by processing circuitry of a handheld device, cause the processing circuitry to perform operations comprising: receiving a signal indicating participation in an access transaction; obtaining context data corresponding to the access transaction; searching, based on the context data, a local data store of the handheld device to locate a subset of access credentials from a set of access credentials stored in the local data store; ordering members of the subset of access credentials based on a predefined metric to create an ordered subset of access credentials; and rendering the ordered subset of access credentials to a user interface of the handheld device for selection by a user of the handheld device to complete the access transaction.

In Example 40, the subject matter of Example 39, wherein a portion of the context data is obtained from a sensor of the handheld device.

In Example 41, the subject matter of Example 40, wherein the portion of the context data is a physical location of the handheld device.

In Example 42, the subject matter of Example 41, wherein the sensor is a satellite positioning device.

In Example 43, the subject matter of any of Examples 39-42, wherein a portion of the context data is received from a terminal participating in the access transaction.

In Example 44, the subject matter of Example 43, wherein the terminal operates to unlock a door or a window.

In Example 45, the subject matter of Example 44, wherein the portion of the context data is an identification of the door or the window.

In Example 46, the subject matter of any of Examples 44-45, wherein the portion of the context data is an identification of a building or complex of buildings that includes the door or the window.

In Example 47, the subject matter of any of Examples 43-46, wherein the terminal operates to complete transactions for an operator.

In Example 48, the subject matter of Example 47, wherein the portion of the context data includes an identification of the operator.

In Example 49, the subject matter of any of Examples 47-48, wherein the portion of the context data includes information about an exchange facilitated by the access transaction.

In Example 50, the subject matter of Example 49, wherein the information about the exchange includes an amount, a type, or a restriction of an object subject to the exchange.

In Example 51, the subject matter of any of Examples 39-50, wherein ordering the members of the subset of access credentials includes performing the ordering using a set of metrics to which the metric belongs.

In Example 52, the subject matter of Example 51, wherein the user interface includes a visual element that displays a portion of the set of metrics with respect to each access credential displayed.

In Example 53, the subject matter of any of Examples 39-52, wherein the set of access credentials include a government identification.

In Example 54, the subject matter of any of Examples 39-53, wherein the set of access credentials include a payment credential.

In Example 55, the subject matter of any of Examples 39-54, wherein the operations comprise receiving selection of an access credential from the user interface.

In Example 56, the subject matter of Example 55, wherein the operations comprise transmitting a form of the access credential based on the selection from the user interface.

In Example 57, the subject matter of any of Examples 55-56, wherein the operations comprise displaying a representation of the access credential to a display of the handheld device based on the selection from the user interface.

Example 58 is a system for access credential sorting, the system comprising: means for receiving, at a handheld device, a signal indicating participation in an access transaction; means for obtaining context data corresponding to the access transaction; means for searching, based on the context data, a local data store of the handheld device to locate a subset of access credentials from a set of access credentials stored in the local data store; means for ordering members of the subset of access credentials based on a predefined metric to create an ordered subset of access credentials; and means for rendering the ordered subset of access credentials to a user interface of the handheld device for selection by a user of the handheld device to complete the access transaction.

In Example 59, the subject matter of Example 58, wherein a portion of the context data is obtained from a sensor of the handheld device.

In Example 60, the subject matter of Example 59, wherein the portion of the context data is a physical location of the handheld device.

In Example 61, the subject matter of Example 60, wherein the sensor is a satellite positioning device.

In Example 62, the subject matter of any of Examples 58-61, wherein a portion of the context data is received from a terminal participating in the access transaction.

In Example 63, the subject matter of Example 62, wherein the terminal operates to unlock a door or a window.

In Example 64, the subject matter of Example 63, wherein the portion of the context data is an identification of the door or the window.

In Example 65, the subject matter of any of Examples 63-64, wherein the portion of the context data is an identification of a building or complex of buildings that includes the door or the window.

In Example 66, the subject matter of any of Examples 62-65, wherein the terminal operates to complete transactions for an operator.

In Example 67, the subject matter of Example 66, wherein the portion of the context data includes an identification of the operator.

In Example 68, the subject matter of any of Examples 66-67, wherein the portion of the context data includes information about an exchange facilitated by the access transaction.

In Example 69, the subject matter of Example 68, wherein the information about the exchange includes an amount, a type, or a restriction of an object subject to the exchange.

In Example 70, the subject matter of any of Examples 58-69, wherein the means for ordering the members of the subset of access credentials include means for performing the ordering using a set of metrics to which the metric belongs.

In Example 71, the subject matter of Example 70, wherein the user interface includes a visual element that displays a portion of the set of metrics with respect to each access credential displayed.

In Example 72, the subject matter of any of Examples 58-71, wherein the set of access credentials include a government identification.

In Example 73, the subject matter of any of Examples 58-72, wherein the set of access credentials include a payment credential.

In Example 74, the subject matter of any of Examples 58-73, comprising receiving selection of an access credential from the user interface.

In Example 75, the subject matter of Example 74, comprising means for transmitting a form of the access credential based on the selection from the user interface.

In Example 76, the subject matter of any of Examples 74-75, comprising means for displaying a representation of the access credential to a display of the handheld device based on the selection from the user interface.

Example 77 is at least one machine-readable medium including instructions that, when executed by processing circuitry, cause the processing circuitry to perform operations to implement of any of Examples 1-76.

Example 78 is an apparatus comprising means to implement of any of Examples 1-76.

Example 79 is a system to implement of any of Examples 1-76.

Example 80 is a method to implement of any of Examples 1-76.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A non-transitory machine readable medium including instructions for access credential sorting, the instructions, when executed by processing circuitry of a handheld device, cause the processing circuitry to perform operations comprising:
receiving a signal indicating participation in an access transaction;
obtaining context data corresponding to the access transaction;
searching, based on the context data, a local data store of the handheld device to locate a subset of access credentials from a set of access credentials stored in the local data store;
ordering members of the subset of access credentials based on a predefined metric to create an ordered subset of access credentials; and
rendering the ordered subset of access credentials to a user interface of the handheld device for selection by a user of the handheld device to complete the access transaction.

2. The non-transitory machine readable medium of claim 1, wherein a portion of the context data is obtained from a sensor of the handheld device.

3. The non-transitory machine readable medium of claim 2, wherein the portion of the context data is a physical location of the handheld device.

4. The non-transitory machine readable medium of claim 3, wherein the sensor is a satellite positioning device.

5. The non-transitory machine readable medium of claim 1, wherein a portion of the context data is received from a terminal participating in the access transaction.

6. The non-transitory machine readable medium of claim 5, wherein the terminal operates to unlock a door or a window.

7. The non-transitory machine readable medium of claim 6, wherein the portion of the context data is an identification of the door or the window.

8. The non-transitory machine readable medium of claim 6, wherein the portion of the context data is an identification of a building or complex of buildings that includes the door or the window.

9. The non-transitory machine readable medium of claim 5, wherein the terminal operates to complete transactions for an operator.

10. The non-transitory machine readable medium of claim 9, wherein the portion of the context data includes an identification of the operator.

11. The non-transitory machine readable medium of claim 9, wherein the portion of the context data includes information about an exchange facilitated by the access transaction.

12. The non-transitory machine readable medium of claim 11, wherein the information about the exchange includes an amount, a type, or a restriction of an object subject to the exchange.

13. The non-transitory machine readable medium of claim 1, wherein ordering the members of the subset of access credentials includes performing the ordering using a set of metrics to which the metric belongs.

14. The non-transitory machine readable medium of claim 13, wherein the user interface includes a visual element that displays a portion of the set of metrics with respect to each access credential displayed.

15. The non-transitory machine readable medium of claim 1, wherein the set of access credentials include a government identification.

16. The non-transitory machine readable medium of claim 1, wherein the set of access credentials include a payment credential.

17. The non-transitory machine readable medium of claim 1, wherein the operations comprise receiving selection of an access credential from the user interface.

18. The non-transitory machine readable medium of claim 17, wherein the operations comprise transmitting a form of the access credential based on the selection from the user interface.

19. The non-transitory machine readable medium of claim 17, wherein the operations comprise displaying a representation of the access credential to a display of the handheld device based on the selection from the user interface.
